(19) United States
(12) Patent Application Publication
(10) Pub. No.: US 2013/0134788 A1
(43) Pub. Date: May 30, 2013

(54) SEMICONDUCTOR DEVICE

(71) Applicant: ELPIDA MEMORY, INC., Tokyo (JP)

(72) Inventor: Hidekazu NOGUCHI, Tokyo (JP)

(73) Assignee: ELPIDA MEMORY, INC., Tokyo (JP)

(21) Appl. No.: 13/679,314

(22) Filed: Nov. 16, 2012

(30) Foreign Application Priority Data
Nov. 24, 2011 (JP) 2011-255762

(51) Int. Cl. H02J 1/00

(52) U.S. Cl. CPC H02J 1/00
USPC 307/75

(57) ABSTRACT

A semiconductor device includes an inverter constituted from first and second transistors connected in series between a first power supply and a second power supply and a first circuit connected between the first and second transistors which have gates coupled together. The first circuit includes a first resistance element of a positive temperature characteristic and a third transistor connected to each other in parallel. The third transistor operates at least in a region where a resistance between drain and source terminals exhibits a negative temperature characteristic.

### TECHNICAL FIELD

### Reference to Related Application

This application is based upon and claims the benefit of the priority of Japanese patent application No. 2011-255762, filed on Nov. 24, 2011, the disclosure of which is incorporated herein in its entirety by reference thereto.

The present invention relates to a semiconductor device.

### BACKGROUND

A CR circuit (CR delay circuit) that includes a capacitance C and a resistor R is used for a timing circuit such as a timer circuit that outputs a signal for each predetermined period of time, an oscillator circuit, or a one-shot pulse generation circuit in a semiconductor device. As is well known, when an ideal step signal is applied to the CR circuit having a time constant τ, a rise time tr and a fall time tf, each of which is a transition period of time between 10% and 90% of a signal amplitude of a voltage across terminals of the capacitance of the CR circuit, are each approximated by 2.2 τ=2.2 RC. As the capacitance in the semiconductor device, a parasitic capacitance or a capacitor element connected to the semiconductor device is used. Though no particular limitation is imposed, a capacitance between adjacent interconnects on a same interconnect layer or a capacitance (parallel-plate capacitance) between upper and lower interconnect layers may be used as the parasitic capacitance of the semiconductor device. As a capacitor element arranged in the device, a Metal Oxide Semiconductor (MOS) capacitor, a junction capacitance between a diffusion layer formed in the surface layer of a semiconductor substrate and the semiconductor substrate (junction capacitance between a diffusion layer in a well and the well) may be used. As a resistor, such resistance as interconnect resistance, resistance of a MOS transistor gate electrode, diffusion-resistance, on-resistance of a MOS transistor or the like may be used.

A change in the capacitance value of a capacitor (parasitic capacitance, MOS capacitor, or the like) due to a change in temperature is comparatively small in a semiconductor device. Generally, a resistance component of a conductor has a positive temperature characteristic (coefficient), where a resistance value thereof increases with an increase in temperature. Consequently, the higher temperature is, the larger the time constant z of the CR circuit is. The rise time and the fall time (delay time) of a signal voltage across the terminals of the capacitor therefore increase. For this reason, an oscillation period or a timer period increases in an oscillator circuit or a timer circuit including the CR circuit. Specifically, the timer period of an internal timer for self refresh in a dynamic random access memory (DRAM) that needs refresh for data retention of a memory element increases. A refresh period therefore increases with an increase in temperature. Patent Literature 1 discloses, as a related art thereof (FIG. 22 in Patent Literature 1) a configuration of a ring oscillator including a plurality of stages of CMOS inverters, in which the oscillation period of an oscillator circuit 400 is reduced with the increase in temperature. In this ring oscillator, a resistance element 418 whose resistance value decreases with an increase in temperature is provided between a drain of a PMOS transistor 414 and a drain of an NMOS transistor 416 in a CMOS inverter 402, as shown in FIG. 10. The resistance element 418 is provided in order to fix an issue that the oscillation period of the oscillator circuit 400 increases in a high temperature region and a DRAM refresh period increases due to the increase in on-resistance of a MOS transistor. A capacitor 420 and a resistor 418 constitute a CR delay circuit. In the ring oscillator in FIG. 10, CMOS inverters 402, 404, 406, and 408 are connected in cascade, and an output 412 of the CMOS inverter 408 in a final stage is fed back to an input of the CMOS inverter 402 in an initial stage through a NAND circuit 410 (that functions as an inverter when an input signal ST is High), for oscillation.

Patent Literature 1 discloses an arrangement in which the oscillation period is reduced in high temperature and increases with lowering in temperature. As shown in FIG. 9, the CMOS inverter in each stage of the ring oscillator includes a capacitance 112 between an output node of the CMOS inverter and a reference voltage terminal (such as a VSS power supply terminal) and a resistor circuit that includes a plurality of resistance elements (118, 120) connected in parallel between a PMOS transistor 114 and an NMOS transistor 116. The resistance elements 118 and 120 have different temperature characteristics. The resistance element (temperature-dependent resistance element) 118 has a characteristic in which a resistance value thereof decreases with the increase in temperature. The resistance element (temperature-independent resistance element) 120 has a characteristic in which a resistance value thereof remains almost unchanged with a change in temperature.

Patent Literature 2 discloses an arrangement in which there are provided first and second resistors connected in series between a drain of a PMOS transistor of a CMOS inverter and a drain of an NMOS transistor of the CMOS inverter, an NMOS transistor connected in parallel with the first resistor, and a fuse with both ends thereof connected to both ends of the second resistor. In this configuration, a delay time is changed by whether or not fuse blowing-out occurs or not.
[Patent Literature 1]
JP Patent Kokai Publication No. JP2005-12404A, which corresponds to US2004/257164A1 and U.S. Pat. No. 7,005,931B2
[Patent Literature 2]
JP Patent Kokai Publication No. JP2002-42466A
[Patent Literature 3]
JP Patent Kokai Publication No. JP2010-232583A, which corresponds to US2010/244908A1
[Non Patent Literature 1]
Kouichi Kanda et al., “Design Impact of Positive Temperature Dependence on Drain Current in Sub-1-V CMOS VLSIs”, IEEE JOURNAL OF SOLID-STATE CIRCUITS VOL. 36, No. 10, OCTOBER, pp. 1559-1564, 2001

### SUMMARY

The following is an analysis of the related art by the inventor of the present invention.

As shown in FIG. 9, in the arrangement disclosed in Patent Literature 1, the resistance element 118 having the characteristic in which the resistance value thereof decreases with an increase in temperature and the resistance element 120 having the characteristic in which the resistance value thereof remains almost unchanged with a change in temperature are connected in parallel. As described in Patent Literature 1, in order to form the resistance element 118 having a negative temperature coefficient, a dedicated interconnect layer must be provided and a dedicated impurity doping process in fabrication of the device is necessary. Further, in order to cause the resistance element 118 to have the negative temperature coefficient, doping is performed with an extremely small amount of impurity. Thus, the sheet resistance of the resistance element 118 extremely increases (e.g., 1.67 Giga Ohm/Square at 100° C. in FIG. 16 in Patent Literature). This leads to the requirement of a large layout area for substantially making the resistance value of the resistance element 118 uniform.

According to the present invention, there is provided a device described as follows, though not limited thereto.

A semiconductor device, in accordance with an aspect of the present invention, comprises:

an inverter including first and second transistors arranged between first and second power supplies having mutually different power supply voltage, the first and second transistors having gate terminals coupled together; and

a first circuit connected between the first and second transistors,

the first circuit including

a first resistance element and a third transistor connected to each other in parallel. The third transistor operates at least in a region of operation in which a resistance between drain and source terminals of the third transistor exhibits a temperature characteristic of a polarity opposite to a polarity of a temperature characteristic of the first resistance element, when charging or discharging a capacitor connected to an output of the inverter.

According to the present invention, temperature dependence of a delay time in a circuit that charges or discharges a capacitance can be mitigated and an increase in a circuit size thereof can be suppressed.

### BRIEF DESCRIPTION OF THE DRAWINGS

FIG. 1 is a diagram illustrating an arrangement of a first exemplary embodiment of the present invention;

FIGS. 2A and 2B are graphs for explaining temperature dependences of drain current—gate voltage (I_{DS}-V_{GS}) characteristics of an NMOSFET and a PMOSFET;

FIG. 3 is a timing waveform diagram explaining operation of the first exemplary embodiment of the present invention;

FIG. 4 is a diagram illustrating an arrangement of a variation example of the first exemplary embodiment of the present invention;

FIG. 5 is a timing waveform diagram explaining operation of the variation example of the first exemplary embodiment of the present invention;

FIG. 6 is a graph for explaining examples of drain current-gate voltage (I_{DS}-V_{GS}) characteristics in the first exemplary embodiment of the present invention;

FIG. 7 is a diagram illustrating an arrangement of a second exemplary embodiment of the present invention;

FIG. 8 is a diagram illustrating an arrangement of a variation example of the second exemplary embodiment of the present invention;

FIG. 9 is a diagram illustrating an arrangement of an inverter disclosed in Patent Literature 1; and

FIG. 10 is a diagram illustrating an arrangement of an oscillator circuit disclosed in Patent Literature 1.

### PREFERRED MODES

A semiconductor device, in accordance with one of embodiments of the present invention, comprises an inverter (11) that includes

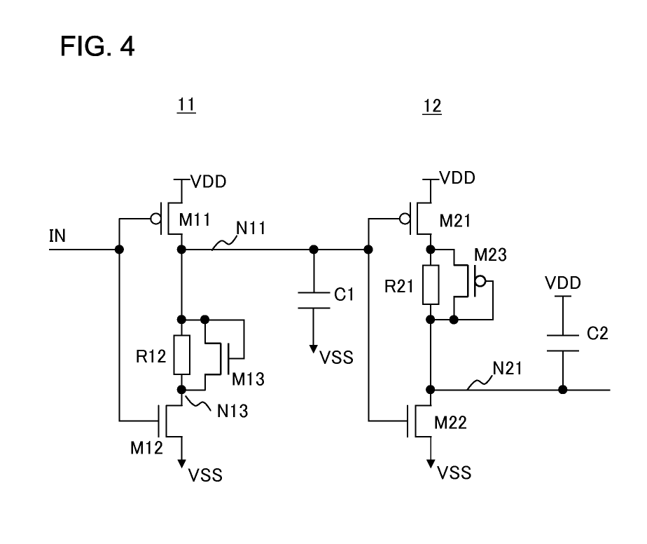

first and second MOSFETs (M11, M12) of mutually opposite conductivity types connected in series between a first power supply and a second power supply having mutually different power supply voltages. When one of the first and second MOSFETs (M11, M12) turns on responsive to a signal level at an input node, the other of the first and second MOSFETs (M11, M12) turns off. Depending on turning on of the first MOSFET or the second MOSFET, a capacitance (C1) with one end thereof connected to an output node of the inverter (11) is charged or discharged. The inverter (11) further includes, as shown in FIG. 4,

a first resistance element (R11) with one end thereof connected to one end of the capacitance (C1) and with the other end thereof connected to a drain of the second MOSFET (M12) and

a third MOSFET (M13) with a drain and a source thereof respectively connected to the one end and the other end of the first resistance element (R12). The first resistance element (R12) has a positive temperature characteristic (temperature coefficient). When discharging the capacitance (C1), a gate-to-source voltage (V_{GS}) of the third MOSFET (M13) is biased to include a voltage range where drain current (I_{DS}) of the third MOSFET (M13) has a positive temperature characteristic. It is so arranged that the third MOSFET (M13) mitigates or reduces the influence of the temperature characteristic of the first resistance element (R12).

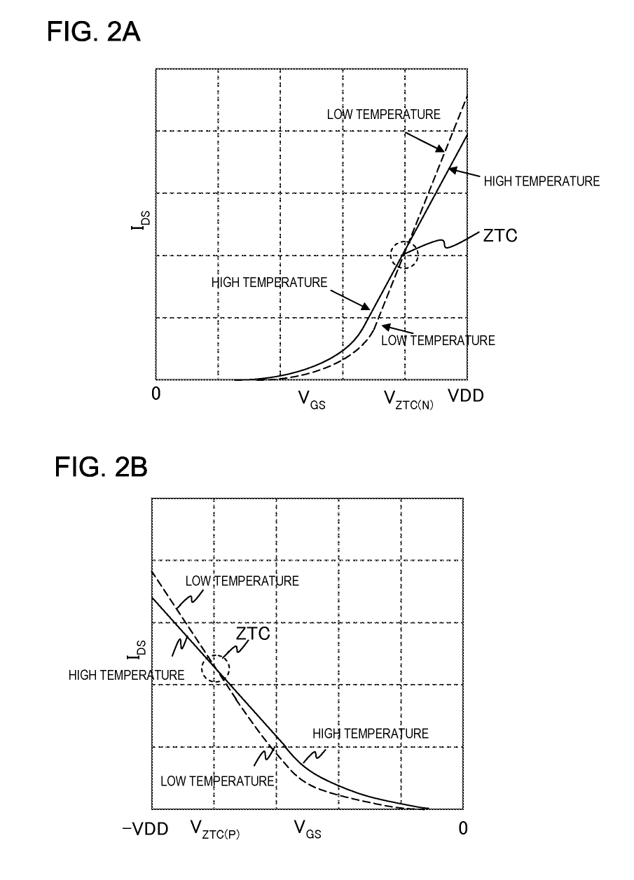

The current value of drain-to-source current I_{DS} of a MOSFET operated in a strong inversion region is smaller at high temperature than at low temperature, where in the strong inversion region, a gate-to-source voltage V_{GS} of the MOSFET is equal to or greater than the threshold voltage thereof. The current value of the drain-to-source current (subthreshold leakage current) of the MOSFET operated in a weak inversion region (subthreshold region) is larger at high temperature than at low temperature, where in the subthreshold region, the gate-to-source voltage of the MOSFET is less than the threshold voltage thereof) (refer to FIG. 2 of Patent Literature 3).

It is known that temperature dependence of the drain-to-source current I_{DS} of the MOSFET is reversed, when the semiconductor device is operated at a low power supply voltage of about 1V, for example (refer to Non Patent Literature 1). To take an example, the current value of a drain current (drain-to-source current I_{DS}) of an NMOSFET is larger at high temperature than at low temperature, when a gate-to-source voltage of the NMOSFET is a predetermined voltage V_{ZTC(N)} or less. This means that the drain current of the NMOSFET has a positive temperature characteristic. The predetermined voltage V_{ZTC(N)} corresponds to a Zero Temperature Coefficient (ZTC) point at which the temperature characteristic of the drain current of the NMOSFET is nearly zero. When the gate-to-source voltage of the NMOSFET is greater than the predetermined voltage V_{ZTC(N)}, the current value of the drain current of the NMOSFET is smaller at high temperature than at low temperature. This means that the drain current of the NMOSFET has a negative temperature characteristic.

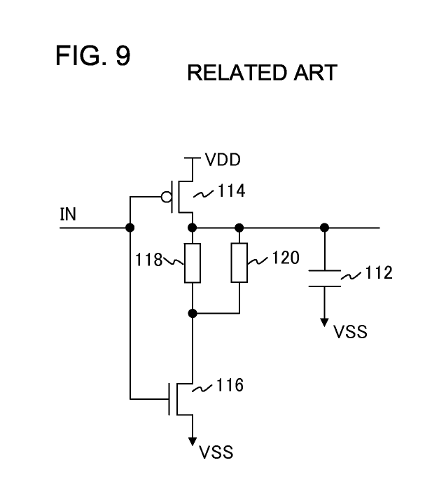

When a drain-to-source current of a MOSFET is equivalently converted to a resistance value between drain and source terminals of the MOSFET, the positive temperature characteristic of the drain-to-source current corresponds to a negative temperature characteristic of the resistance between drain and source terminals of the MOSFET, when the gate-to-source voltage of the MOSFET is the predetermined voltage (V_{ZTC(N)}) or less. According to one of the embodiments, the gate-to-source voltage of the MOSFET (M13) connected in parallel with the resistance element (R12) is biased to cause the MOSFET (M13), when discharging the capacitance (C1), to operate at least in a region in which the drain current of the MOSFET (M13) has a positive temperature characteristic. With this arrangement, temperature dependence of a time constant in discharging the capacitance (C1) is mitigated. Compared with the configuration including a resistance element having a negative temperature characteristic as described with reference with FIG. 9, complication and increase in fabrication processes can be avoided. Further, an increase in the circuit size can be suppressed. A more detailed description will be given below.

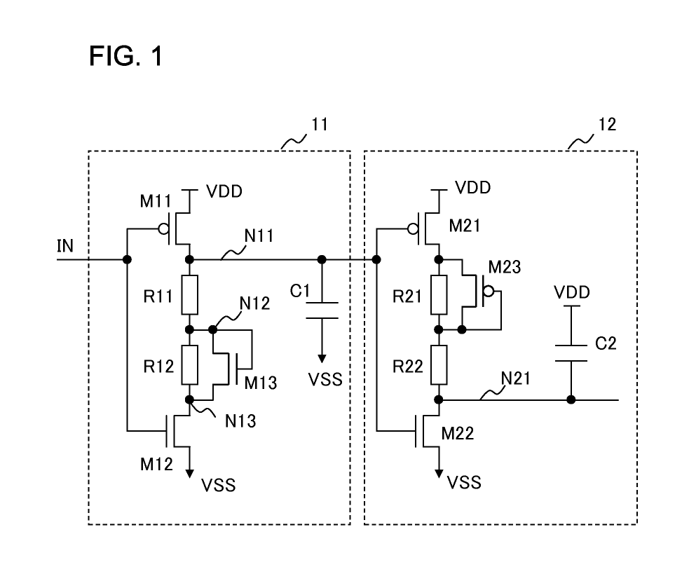

FIG. 1 is a diagram illustrating an arrangement of one exemplary embodiment of the present invention. Referring to FIG. 1, an inverter 11 in an initial stage includes:

a PMOS transistor (PMOSFET) M11 that has a source connected to a first power supply VDD, has a drain connected to a node N11, and has a gate to receive an input signal IN, where the first power supply VDD supplies a high-potential power supply voltage;

an NMOS transistor (NMOSFET) M12 that has a source connected to a second power supply VSS, and has a gate connected with the gate of the PMOS transistor M11 to receive the input signal IN in common with the PMOS transistor M11, where the second power supply VSS supplies a low-potential power supply voltage;

a resistor R11 that has one end connected to the drain node N11 of the PMOS transistor M11;

a resistor R12 that has one end connected to the other end of the resistor R11 and has the other end connected to a drain of the NMOS transistor M12; and

an NMOS transistor M13 that has a drain and a gate coupled together to the other end of the resistor R11 and has a source connected to the drain of the MOS transistor M12. A capacitor C1 is connected between the drain node N11 of the PMOS transistor M11 and the second power supply VSS. The NMOS transistor M13 that has the drain and the gate coupled together. This configuration in which the MOS transistor has a drain and a gate coupled together is termed as a diode connection configuration.

An inverter 12 in a subsequent stage includes:

a PMOS transistor M21 that has a source connected to the power supply VDD and has a gate connected to the node N11;

an NMOS transistor M22 that has a source connected to the power supply VSS and has a gate, together with the gate of the PMOS transistor M21, connected in common to the node N11 of the inverter 11;

a resistor R22 that has one end connected to a drain node N21 of the NMOS transistor M22;

a resistor R21 that has one end connected to the connection node of the other end of the resistor R22 and a drain of the PMOS transistor M21 and has the other connected to a drain of the PMOS transistor M21; and

a PMOS transistor M23 that has a drain and a gate coupled together to the other end of the resistor R22, and has a source connected to the drain of the PMOS transistor M21. A capacitor C2 is connected between the drain node N21 of the NMOS transistor M22 and the first power supply VDD.

Though not limited thereto, the capacitor C1 in FIG. 1 is formed of an NMOS transistor (MOS capacitor) that has a gate connected to the node N11 and has a source and a drain thereof connected in common to the power supply VSS. The capacitor C2 is formed of a PMOS transistor (MOS capacitor) with a gate thereof connected to the node N21 and with a source and a drain thereof connected in common to the power supply VDD.

FIG. 1 shows two stages of the inverters 11 and 12. In case the semiconductor device is configured to include three or more stages of inverters connected in cascade, an output of the inverter 12 is connected to an input of an inverter having the same configuration as the inverter 11 in the initial stage, and the inverters 11 and 12 are alternately connected. In case the semiconductor device is so configured to include odd number of stages of inverters connected in cascade, an inverter in a final stage is configured to be the same as the inverter 11. In case the semiconductor device is so configured to include even number of stages of inverters connected in cascade, an inverter in a final stage is configured to be the same as the inverter 12. The arrangement of the inverter 11 and the inverter 12 is not limited to the order shown in FIG. 1. There may be provided such an arrangement in which the inverter 12 is arranged in an initial stage and the inverter 11 is arranged in a subsequent stage.

The resistance elements R11, R12, R21, and R22 are each a metal resistor or a diffusion layer resistor, as is commonly used, and have each a positive temperature characteristic (a characteristic of a conductor), where a resistance value thereof increases with an increase in temperature.

Referring to FIG. 1, a power supply voltage VDD is set to a voltage sufficiently higher than the sum of an absolute value |V_{Tp}| of the threshold value of the PMOS transistor M11 and a threshold value V_{TN} of the NMOS transistor M12. Further, the power supply voltage VDD is set to a voltage sufficiently higher than the sum of an absolute value |V_{Tp}| of the threshold value of the PMOS transistor M21 and a threshold value V_{TN} of the NMOS transistor M22. On-resistances of the NMOS transistors M12 and M22 and on-resistances of the PMOS transistor M11 and M21 have each a positive temperature characteristic. For example, the current value of a drain current of the NMOS transistor M12 in a strong inversion region where a gate-to-source voltage V_{GS} of the NMOS transistor M12 is equal to or more than the threshold voltage V_{TN}, is smaller at high temperature than at low temperature and hence the on-resistance of the NMOS transistor M12 is larger at high temperature than at low temperature. Thus, the on-resistance of the NMOS transistor M12 has a positive temperature characteristic (coefficient).

FIGS. 2A and 2B are graphs respectively explaining I_{DS}-V_{GS} characteristics of an NMOSFET and a PMOSFET in a low-voltage region (refer to FIG. 1 in Non Patent Literature 1). In case a gate-to-source voltage V_{GS} of the NMOSFET is less than or equal to a predetermined voltage (V_{ZTC(N)}), as shown in FIG. 2A, the current value of a drain current (drain-to-source current)I_{DS} when the NMOSFET is conductive (on) is larger at high temperature than at low temperature. A resistance value (on-resistance) between drain and source terminals of the NMOSFET, into which the drain current thereof is equivalently converted, has a negative temperature characteristic. On the other hand, in case the gate-to-source voltage V_{GS} is greater than the predetermined voltage (V_{ZTC(N)}), the current value of the drain-to-source current I_{DS} is larger at low temperature than at high temperature. A resistance value (on-resistance) between drain and source terminals of the NMOSFET, into which the drain current thereof is equivalently converted, has a positive temperature characteristic. When the gate-to-source voltage V_{GS} is the predetermined voltage (V_{ZTC(N)}), the drain-to-source current I_{DS} at high temperature crosses the drain-to-source current I_{DS} at low temperature, so that the drain-to-source current I_{DS} has a temperature characteristic of zero. A point where the drain-to-source current I_{DS} at high temperature crosses the drain-to-source current I_{DS} at low temperature is referred to as a ZTC (Zero Temperature Coefficient) point. The gate-to-source voltage V_{GS} at the ZTC point where the temperature characteristic of the drain-to-source current I_{DS} is zero is denoted by V_{ZTC(N)}. The voltage V_{ZTC(N)} is usually in the vicinity of a threshold voltage V_{THN} of the NMOSFET.

In case a gate-to-source voltage V_{GS} (<0) of the PMOSFET is higher than a predetermined voltage V_{ZTC(P)}(<0) (in case the absolute value of the gate-to-source voltage V_{GS} is smaller than the absolute value of the voltage V_{ZTC(P)}), as shown in FIG. 2B, the current value of a drain current (source-to-drain current) I_{DS}, when the PMOSFET is conductive (on), is larger at high temperature than at low temperature. A resistance value (on-resistance) between drain and source terminals of the PMOSFET, into which the drain current thereof is equivalently converted, has a negative temperature characteristic. On the other hand, when the gate-to-source voltage V_{GS} (<0) is lower than the predetermined voltage (V_{ZTC(P)})(<0), the current value of the drain current I_{DS} of the PMOSFET is larger at low temperature than at high temperature. A resistance value (on-resistance) between drain and source terminals of the PMOSFET, into which the drain current thereof is equivalently converted, has a positive temperature characteristic. In case the gate-to-source voltage V_{GS} is the predetermined voltage (V_{ZTC(P)}), the drain-to-source current I_{DS} at high temperature crosses the drain-to-source current I_{DS} at low temperature, so that the drain-to-source current I_{DS} has a temperature characteristic of zero. The voltage V_{ZTC(P)}(<0) is usually in the vicinity of a threshold voltage V_{THP} (<0) of the PMOSFET.

The drain-to-source current I_{DS} of the MOS transistor in a saturation region is generally expressed by Equation (1) (refer to Non Patent Literature 1). Referring to FIG. 1, the drain and the gate of the MOS transistor M13 are connected and a drain-to-source voltage V_{DS} of the MOS transistor M13 is equal to a gate-to-source voltage V_{GS} of the MOS transistor M13, and hence V_{DS}>V_{GS}−V_{TH} (V_{TH}: threshold voltage) holds. The MOS transistor M13 operates in the saturation region.

I_{DS}∝μ(T)×(V_{GS}−V_{TH}(T))^{α} (1)

where μ (T) is a carrier mobility at a temperature (absolute temperature) T, V_{TH}(T) is a threshold voltage at the temperature (absolute temperature) T. α is a coefficient in an exponential term showing dependence of the drain-to-source current I_{DS} on the gate-to-source voltage V_{GS} (α=1˜2, for example). The threshold voltage V_{TH}(T) and the mobility μ(T) at the temperature (absolute temperature) T are respectively given by the following Equations (2) and (3):

$$\begin{matrix}{V}_{TH} ( T ) = {V}_{TH} ( {T}_{0} ) - κ ( T - {T}_{0} ) & ( 2 ) \\ {μ}_{e} = {μ}_{0} ( {T}_{0} ) {( \frac{T}{{T}_{0}} )}^{- m} & ( 3 )\end{matrix}$$

In Equation (2), κ (>0) is a temperature coefficient, and is 2.5 mV/K (where K means Kelvin), for example. In Equation (3), m is given by 3/2 (=1.5), for example. Tₒ is a predetermined reference temperature, and T₀=273.15+25=298.15 K (absolute temperature) at 25° C. (room temperature).

The threshold voltage V_{TH}(T) has a negative temperature characteristic (where the value of the threshold voltage V_{TH}(T) is smaller at high temperature than at low temperature), and the mobility μ (T) also has a negative temperature characteristic. Since the threshold voltage V_{TH}(T) is multiplied by a minus sign in Equation (1), the threshold voltage V_{TH}(T) functions as a positive value in the temperature characteristic of the drain-to-source current I_{DS} of the MOSFET. When Equations (2) and (3) are substituted into the right side of Equation (1) to take the logarithm of the resulting Equation, the following Equation (4) is obtained.

$$log ( {I}_{DS} ) ∝ log [ {μ}_{0} ( {T}_{0} ) {( \frac{T}{{T}_{0}} )}^{- m} ] + α log [ {V}_{GS} - {V}_{TH} ( {T}_{0} ) + κ ( T - {T}_{0} ) ] \qquad ( 4 )$$

When Equation (4) is differentiated by the temperature T, the following Equation (5) is obtained:

$$\frac{\partial log ( {I}_{DS} )}{\partial T} ∝ - m ( \frac{1}{T} ) + \frac{α \times κ}{{V}_{GS} - {V}_{TH} ( {T}_{0} ) + κ ( T - {T}_{0} )} \qquad ( 5 )$$

The first term (having a negative value) of the right side of Equation (5) has a larger value at high temperature than at low temperature, and the second term (having a positive value) of the right side of Equation (5) has a smaller value at high temperature than at low temperature. When a differential coefficient obtained by differentiation of the drain-to-source current I_{DS} by the temperature T becomes zero, the temperature characteristic of the drain-to-source current I_{DS} becomes zero. This indicates that the value of Equation (5) becomes zero, when T is set to a predetermined value in Equation (5). Accordingly, Equation (6) holds, and Equation (8) is obtained.

$$\begin{matrix}\frac{m}{T} = \frac{α \times κ}{{V}_{GS} - {V}_{TH} ( {T}_{0} ) + κ ( T - {T}_{0} )} & ( 6 ) \\ {V}_{GS} - {V}_{TH} ( {T}_{0} ) + κ ( T - {T}_{0} ) = \frac{α \times κ \times T}{m} & ( 7 ) \\ ∴ & \\ {V}_{GS} = {V}_{TH} ( {T}_{0} ) - κ ( T - {T}_{0} ) + \frac{α \times κ \times T}{m} & ( 8 )\end{matrix}$$

When T=T₀ in Equation (8), the following Equation (9) is obtained.

$${V}_{GS} = {V}_{TH} ( {T}_{0} ) + \frac{α \times κ \times {T}_{0}}{m} \qquad ( 9 )$$

V_{GS} in Equation (9) gives one (approximate value) of the gate-to-source voltages V_{GS} (V_{ZTC}) at the ZTC point in a predetermined temperature range including T=T₀.

As shown in FIG. 2A, the temperature characteristic of the drain-to-source current I_{DS} of the NMOSFET changes according to the gate-to-source voltage V_{GS}. In case of V_{GS}<V_{ZTC(N)}, the temperature characteristic of the drain-to-source current I_{DS} is positive (which means that the current value of the drain-to-source current I_{DS} increases with an increase in temperature). In case of V_{GS}>V_{ZTC(N)}, the temperature characteristic of the drain-to-source current I_{DS} is negative (which means that the current value of the drain-to-source current I_{DS} decreases with an increase in temperature). In case of V_{GS}=V_{ZTC(N)}, the temperature characteristic of the drain-to-source current I_{DS} is zero. The above is explanation of the gate-to-source voltage V_{GS} at the ZTC point.

Referring to FIG. 1 again, a voltage at the node N11 is divided by the resistors R11 and R12 so that the gate-to-source voltage V_{GS} of the NMOS transistor M13 becomes less than or equal to the voltage at the ZTC point. When the input signal IN rises to a High level(=VDD) and the NMOS transistor M12 turns on to discharge electric charge in the capacitor C1 to the power supply VSS, a voltage to be applied between the gate and the source of the NMOS transistor M13 becomes the voltage V_{ZTC(N)} or less. Thus, the current value of the drain-to-source current I_{DS} of the NMOS transistor M13 that operates in the saturation region has the positive temperature characteristic in which the current value of the drain-to-source current I_{DS} is larger at high temperature than at low temperature. A resistance between drain and source terminals of the NMOS transistor M13 has a negative temperature characteristic in which the resistance value is smaller at high temperature than at low temperature.

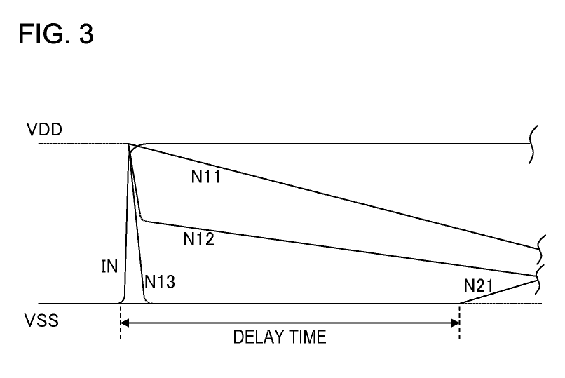

FIG. 3 is a waveform diagram for explaining operation of the circuit in FIG. 1. FIG. 3 shows voltage waveforms of the input signal IN and the nodes N11, N12, and N13. In FIG. 1, when the input signal IN is at a Low level (of a supply voltage VSS), the PMOS transistor M11 turns on, and the NMOS transistor M12 turns off. The capacitor C1 is charged from the power supply VDD through the PMOS transistor M11. That is, the node N11 is precharged to a High potential (=power supply potential VDD) (an electric charge of C1×VDD is accumulated in the capacitor C1). The NMOS transistor M12 is off, and the nodes N12 and N13 are not connected to the power supply VSS and are connected to the power supply VDD through the PMOS transistor M11 that is in an on state. Thus, the nodes N12 and N13 are both made to have the power supply voltage VDD. The gate-to-source voltage V_{GS} of the NMOS transistor M13 is given by a difference voltage between the nodes N12 and N13. Potentials of the nodes N12 and N13 are equal, and hence the difference voltage between the nodes N12 and N13 is less than or equal to the threshold voltage of the NMOS transistor M13. Thus, the NMOS transistor M13 is set in an off state. When the input signal IN is Low and the node N11 goes High, the NMOS transistor M22 of the inverter 12 in the second stage turns on, the PMOS transistor M21 turns off, a node N21 assumes a power supply potential VSS, and then the second capacitor C2 is charged (the accumulated electric charge Q of the capacitor C2=C2×VDD).

When the input signal IN is transitioned from the Low level to the High level (VDD) from this state, the NMOS transistor M12 turns on, the PMOS transistor M11 turns off, and the node N13 is rapidly discharged to a VSS level. Then, the node N12 assumes a voltage obtained by dividing the potential at the node N11 by the resistors R11 and R12. Resistance values of the resistors R11 and R12 are set so that, preferably the voltage at the node N12 is less than or equal to the voltage at the ZTC point in FIG. 2 and is greater than or equal to the threshold voltage of the NMOS transistor M13.

The electric charge (Q=C1×VDD) accumulated in the capacitor C1 is discharged and hence the potentials at the nodes N11 and N12 gradually fall.

The gate-to-drain voltage of the NMOS transistor M13, which is equal to the gate-to-source voltage V_{GS} of the MOS transistor M13, is reduced to be less than or equal to the voltage V_{ZTC(N)} at the ZTC point in FIG. 2A. The drain current of the NMOS transistor M13 increases with the increase in temperature, and a resistance R13(T) between the drain and source terminals of the NMOS transistor M13 exhibits the negative temperature characteristic. The resistance R13(T) between the drain and source terminals of the NMOS transistor M13 is approximated by the following Equation (10):

R13(T)=R13(T₀)×(1−a1(T−T₀)) (10)

where T₀ is a predetermined reference temperature (such as room temperature), R13(T₀) is a resistance between the drain and source terminals of the NMOS transistor M13 at the reference temperature T₀. The temperature coefficient of the resistance R13 (T) is −a1, which is a negative value (a1>0).

A resistance R12(T) of the resistor R12 is given by the following Equation (11):

R12(T)=R12(T₀)×(1+a2(T−T₀)) (11)

where R12 (T₀) is the resistance value of the resistor R12 at the reference temperature T₀. The temperature coefficient of the resistance R12(T) is a2 (>0).

The value of the resistance R12 (T) of the resistor R12 is larger at high temperature than at low temperature. However, the resistance R13 (T) between the drain and source terminals of the NMOS transistor M13 is smaller at high temperature than at low temperature. For this reason, an increase in a resistance value of a parallel synthesis resistance R_{P}=R12∥R13 (T) at high temperature is suppressed.

The parallel synthesis resistance R_{P}=R12∥R13(T) is given by:

1/R_{P}=1/R12+1/R13(T) (12)

Referring to Equation (12), with the increase in temperature, 1/R12 decreases but 1/R13 (T) increases, thereby mitigating a decrease in 1/R_{P}. That is, the MOS transistor M13 functions to mitigate, reduce, or cancel out the positive temperature characteristic of the resistor R12.

Conversely, the resistance value of the resistor R12 is lower at low temperature than at high temperature. However, the current value of the drain-to-source current I_{DS} of the NMOS transistor M13 is smaller at low temperature than at high temperature, so that the resistance R13(T) between the drain and source terminals is larger at low temperature than at high temperature. For this reason, a decrease in the parallel synthesis resistor R_{P}=R12//R13(T) at low temperature is suppressed due to the resistance R13(T).

When the on-resistance of the NMOS transistor M12 is indicated by Ron 12, a resistance component on a path between the node N11 and the power supply VSS, which is the discharge path of the capacitor C1, is given by:

R=R11+R12//R13+Ron12 (13)

A time constant τ is given by τ=CR. A fall time tf represented by the time constant τ is given by tf=2.2 CR. The temperature characteristic of the parallel synthesis resistance in the second term of the right side in Equation (13) mitigates or reduces a change in temperature and mitigates the temperature characteristic of the fall time tf.

A period of time from when the voltage at the node N11 gradually falls to when a discharge operation of the inverter in the subsequent stage starts (rise of the node N21 from the power supply voltage VSS to the power supply voltage VDD is started) determines the delay time of the inverter per stage (refer to “delay time” in FIG. 3). The inverter in the subsequent stage starts the discharge operation (where the PMOS transistor M21 turns on, the NMOS transistor M22 turns off, and the node N21 starts to rise) when the voltage at the node N11 becomes approximately a half of the power supply voltage VDD (0.5×VDD). Thus, the MOS transistor M13 is biased to operate in the state of the negative temperature characteristic. During the delay time until the inverter in the subsequent stage starts operation (from when the node N11 falls from the power supply voltage VDD), the negative temperature characteristic of the NMOS transistor N13 mitigates or cancels out the influence of the positive temperature characteristic (temperature coefficient) of the resistor R12.

With respect to the inverter (formed of the PMOS transistors M21 and M23, the NMOS transistor M22, the resistors R21 and R22, and the capacitor C2) in the second stage as well, an absolute value |V_{GS}| of the gate-to-source voltage of the PMOS transistor M23 is set to be less than or equal to an absolute value |V_{ZTC(P)}|. Drain current of the PMOS transistor M23 is larger at high temperature than at low temperature, and a resistance between drain and source terminals of the PMOS transistor M23 has a negative temperature characteristic. For this reason, the PMOS transistor M23 mitigates influence of the resistor R22 having a positive temperature characteristic (temperature coefficient) when temperature changes.

### Variation Example of First Exemplary Embodiment

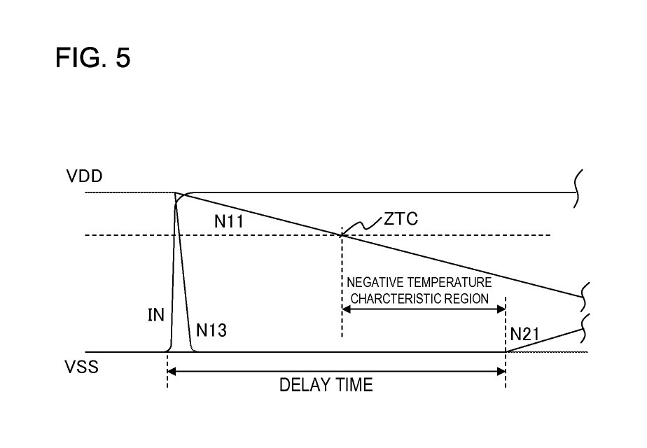

FIG. 4 is a diagram illustrating a variation example of the first exemplary embodiment, as a second example of the first exemplary embodiment. Referring to FIG. 4, the resistor R11 is removed from the inverter 11 in the first stage of FIG. 1, and the resistor R22 is removed from the inverter 12 in the second stage of FIG. 1. A gate-to-source voltage V_{GS} of the NMOS transistor M13 in FIG. 4 is a voltage between voltages at the nodes N11 and N13. When the voltage V_{ZTC(N)} for the gate-to-source voltage V_{GS} of the NMOS transistor at the ZTC point in FIG. 2A (refer to FIG. 2A) is set to VDD×0.8, the temperature characteristic of the NMOS transistor M13 becomes just zero approximately at the voltage of VDD×0.8, and becomes negative at a voltage less than or equal to VDD×0.8. Thus, the temperature characteristic of a resistance between the drain and source terminals of the MOS transistor M13 becomes negative in the period of a voltage waveform N11 indicated as a “negative temperature characteristic region” in FIG. 5.

In case the time constant r of the node N11 is small or in case the power supply voltage VDD is extremely higher than a voltage at which the temperature characteristic of a resistance between the drain and source terminals of the MOS transistor M13 becomes negative, it is preferable in terms of design using the power supply voltage VDD and a capacitance value C1 that a voltage obtained by dropping the voltage at the node N11 by the resistor R11 is applied as the gate-to-source voltage V_{GS} of the NMOS transistor M13 as in the first exemplary embodiment.

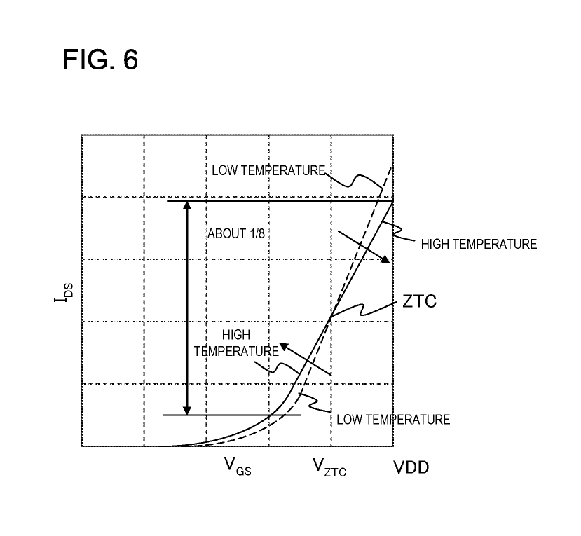

As shown in FIG. 6, when a gate-to-source voltage of the NMOS transistor M13 is set to a voltage in the vicinity of the threshold voltage V_{TH}, the current value of drain-to-source current I_{DS} of the NMOS transistor M13 that flows is, for example, about one eighth of the current value of drain-to-source current that flows when the gate-to-source voltage V_{GS} of the NMOS transistor M13 is set to the power supply voltage VDD.

When an input signal IN is at a High level (=VDD), a gate-to-source voltage V_{GS} of the NMOS transistor M12 is set to the power supply voltage VDD. A drain-to-source current of the NMOS transistor M12 in this state is indicated by I_{DS(M12)}. The NMOS transistor M13 is configured to have a gate size (gate width W) larger than that of the NMOS transistor M12. This configuration is adopted so as to cause the drain-to-source current I_{DS} of the NMOS transistor M13, a current value of which is set to one eighth of the current value of the drain-to-source current when the gate-to-source voltage V_{GS} of the NMOS transistor M13 is set to the power supply voltage VDD, to approximately correspond to the drain-to-source current I_{DS (M12)} of the NMOS transistor M12 which has the gate-to-source voltage V_{GS} of the NMOS transistor M12 set to the power supply voltage VDD. When the capacitor C1 is discharged, the drain-to-source current I_{DS (M12)} that flows through the NMOS transistor M12 (whose gate voltage=VDD) is the sum of currents that respectively branch into the resistor R12 and the NMOS transistor M13 that constitute a parallel circuit. Thus, the gate width W of the NMOS transistor M13 is set to a value (e.g., about three times the gate width of the NMOS transistor M12) that is smaller than eight times the gate width of the NMOS transistor M12, in accordance with the resistance value of the resistor R12.

The NMOS transistor M13 is connected in parallel with the resistor R12 and hence the gate size (gate width) of the NMOS transistor M13 does not need to be reduced or increased to an excessive degree. The same also holds true for the PMOS transistor M23 connected in parallel with a resistor R21 in the second stage in FIG. 4.

### Second Exemplary Embodiment

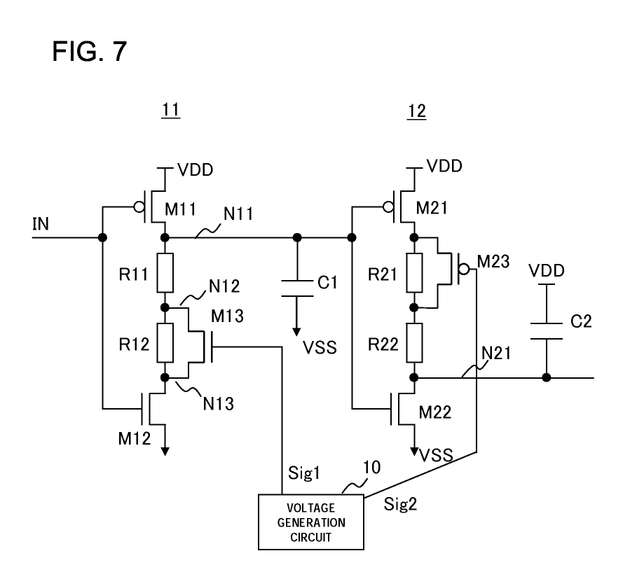

FIG. 7 is a diagram illustrating an arrangement of a second exemplary embodiment of the present invention. In the first exemplary embodiment and the variation example of the first exemplary embodiment shown in FIGS. 1 and 4, each of the NMOS transistor M13 of the inverter 11 in the first stage and the PMOS transistor M23 of the inverter 12 in the second stage has a diode-connected configuration in which the gate and the drain thereof are connected. In this exemplary embodiment, an NMOS transistor M13 in an inverter 11 in a first stage and a PMOS transistor M23 in an inverter 12 in a second state are used as MOS transistors. A voltage less than or equal to the voltage at the ZTC point in FIG. 2A is applied to the NMOS transistor M13, and a voltage whose absolute value is less than or equal to the absolute value of the voltage at the ZTC point in FIG. 2B is supplied the PMOS transistor M23 from a voltage generation circuit 10, as a gate voltage (gate-to-source voltage) Sig1 of the NMOS transistor M13 and a gate voltage (gate-to-source voltage) Sig2 of the PMOS transistor M23. Negative temperature characteristics of voltages between drain and source terminals of the NMOS transistor M13 and the PMOS transistor M23 can be thereby obtained.

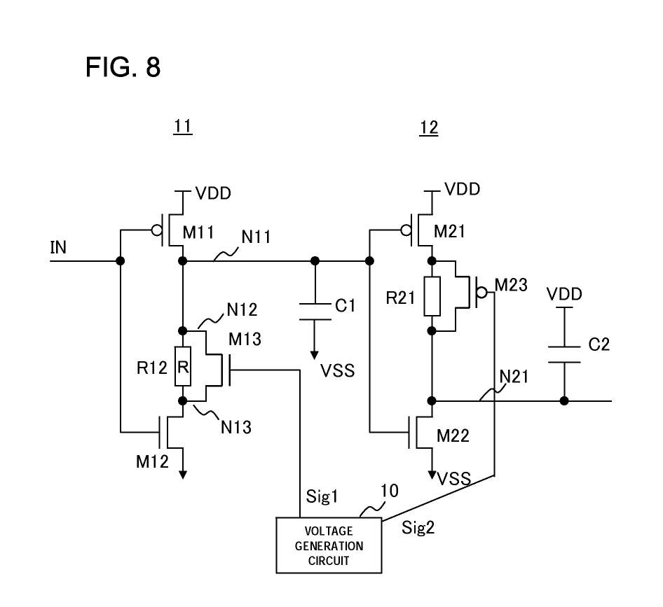

In case a power supply voltage VDD is not so high as a voltage at which the temperature characteristic of a resistance between the drain and source terminals of the MOS transistor M13 becomes negative, a configuration in FIG. 8 is used. As shown in FIG. 8, resistors R11 and R22 may be omitted in this configuration to mitigate positive temperature characteristics of resistors R12 and R21.

As the voltage generation circuit 10 in this exemplary embodiment, a constant voltage generation circuit (reference voltage generation circuit such as a band gap reference circuit generating a voltage which does not depend on temperature) is used. Each output voltage of the voltage generation circuit 10 applied to each of the gates of the NMOS transistor M13 and the PMOS transistor M23 can be readily provided by selecting an output tap of a reference voltage in the voltage generation circuit 10, by adjusting means, such as fuses arranged in the voltage generation circuit 10. Though no particular limitation is imposed, it may also be so arranged that fuses corresponding to unselected reference voltage taps in the voltage generation circuit 10 may be blown off, based on a result of a test about a propagation delay time at each of high (hot) and cold (low) temperatures in the fabrication process of the semiconductor device to adjust the voltages applied to gates of the NMOS transistors M13 and the PMOS transistor M23.

The gate voltage Sig1 is set within the range of 0.4 to 0.8V, for example. If the gate voltage of the PMOS transistor M23 has a characteristic that is shifted to be higher than the gate voltage of the NMOS transistor M13 by 0.1V, the gate voltage Sig2 is set within the range of 0.5 to 0.9V. The gate voltages Sig1 and Sig2 may also be derived, based on simulation results of NMOSFET and PMOSFET I_{DS}-V_{GS} characteristics, or the simulation results and actual measurement results of the NMOSFET and PMOSFET I_{DS}-V_{GS} characteristics using threshold voltage temperature dependence models and mobility temperature dependence models of SPICE MOSFET models (such as BSIM3v3.1 models).

According to the above-described exemplary embodiment, the MOSFETs (M13 and M23) each having a negative temperature characteristic are provided as elements for mitigating the positive temperature characteristics of the resistance elements. A routinely used CMOS process can be thereby applied, without alteration, and gate sizes of the MOSFETs (M13 and M23) do not need to be excessively increased. For this reason, as compared with Patent Literature 1, the number of manufacturing steps can be reduced, and temperature dependence of a propagation delay time per stage of the delay circuit can be reduced, while suppressing the size of each circuit element and an increase in the circuit area.

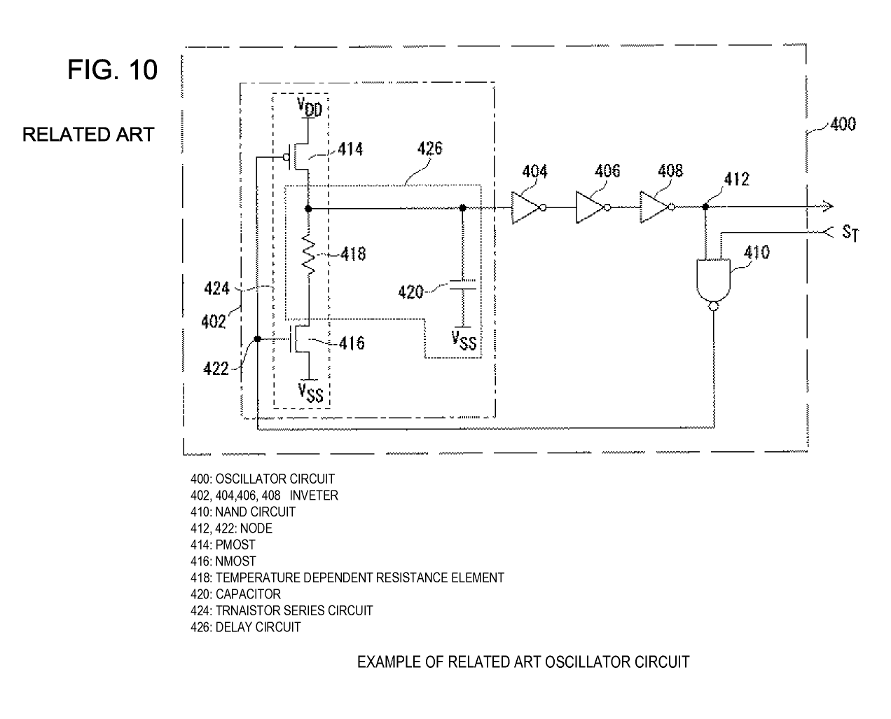

The above-mentioned exemplary embodiment can be applied to a ring oscillator including a plurality of stages of inverters, as shown in FIG. 10, for example. The ring oscillator is not, however, limited to a timer for self-refreshing a DRAM memory cell. One of the inverter 11 and the inverter 12 in FIG. 1 or FIG. 4 may be connected in cascade to form the plurality of stages of inverters. Each of the capacitances C1 and C2 may be a capacitance (parallel plate capacitance) between interconnects on upper and lower interconnect layers, though not limited thereto.

Each of the above-mentioned exemplary embodiments can be applied to an arbitrary signal transmission circuit such as a delay circuit row including a plurality of stages of inverters, and an arbitrary system.

As described above, the technical concept of this application can be applied to an arbitrary semiconductor device including a signal transmission circuit. Further, a circuit form in each circuit block and any other circuit for generating a control signal disclosed in the drawings are not limited to the circuit forms disclosed in the examples.

The technical concept of the semiconductor device of the present invention can be applied to various semiconductor devices. The present invention can be applied to semiconductor devices in general such as Central Processing Unit (CPU), Micro Control Unit (MCU), Digital Signal Processor (DSP), Application Specific Integrated Circuit (ASIC), Application Specific Standard Product (ASSP), and Memory (memory), for example. As such a product form to which the present invention is applied, system on chip (SOC), multi-chip package (MCP), or Package on Package (POP) can be pointed out. The present invention can be applied to the semiconductor devices having these arbitrary product forms and package forms. The transistors should be field effect transistors (Field Effect Transistors; FETs). The present invention can be applied to various FETs such as Metal-Insulator Semiconductors (MISs) and Thin Film Transistors (TFTs), in addition to the Metal Oxide Semiconductors (MOSs). Further, a bipolar transistor may be provided for a part of the semiconductor device. Further, the PMOS transistor (P-type channel MOS transistor) is a typical example of a first conductivity type, while the NMOS transistor (N-type channel MOS transistor) is a typical example of a second conductivity type.

When the resistor R12 is configured to have a negative temperature characteristic in the semiconductor device in each of FIGS. 1, 4, 7, and 8, a related invention (comparative example) where the MOS transistor M13 is made to have a positive temperature characteristic may be theoretically conceived. The positive temperature characteristic is obtained by giving a gate-to-source voltage greater than or equal to the gate-to-source voltage at the ZTC point to the MOS transistor M13 to cause the current value of drain current of the MOS transistor M13 to be lower at high temperature than at low temperature. This configuration is not included in the above-mentioned exemplary embodiments. Further, a related invention (comparative example) may be theoretically conceived where the resistor R12 is replaced with a MOS transistor and a gate-to-source voltage greater than or equal to the gate-to-source voltage at the ZTC point is supplied to the MOS transistor from the voltage generation circuit 10 in FIG. 8 or the like. In this configuration, the MOS transistor is made to have a negative temperature characteristic in which the current value of drain current of the MOS transistor is lower at high temperature than low temperature. A resistance between drain and source terminals of the MOS transistor has a positive temperature characteristic. It is so configured that this positive temperature characteristic is mitigated by the negative temperature characteristic of a resistance between the drain and source terminals of the MOS transistor M13.

The disclosure may be summarized in the following supplementary notes, thought not limited thereto.

(Supplementary note 1) A semiconductor device comprising: an inverter including: an input node to receive a signal;

an output node to output an inverted version of the received signal;

first and second transistors arranged between first and second power supplies having mutually different power supply voltages, the first and second transistors having gate terminals coupled together to the input node, wherein when one of the first and second transistors turns on in response to a signal level at the input node, the other of the first and second transistors turns off;

a capacitor having one end connected to the output node, wherein when the first transistor turns on, the capacitor is charged, and when the second transistor turns on, the capacitor is discharged;

a first resistance element having one end connected to the one end of the capacitor and having the other end connected to a drain of the second transistor, the first resistance element having a positive temperature characteristic; and

a third transistor having drain and source terminals respectively connected to the one end and the other end of the first resistance element, the third transistor having a gate-to-source voltage biased to operate at least in a region of operation in which a drain current of the third transistor has a positive temperature characteristic, when the capacitor is discharged.

(Supplementary note 2) The semiconductor device according to supplementary note 1, wherein when the first transistor turns on, the capacitor is charged, and when the second transistor turns on, the capacitor is discharged,

the other end of the first resistance element is connected to the drain of the second transistor,

the inverter further includes

a second resistance element connected between the one end of the capacitor and a connection node between the one end of the first resistance element and the drain of the third transistor, a voltage obtained by dividing a voltage between terminals of the capacitor being applied to the drain of the third transistor.

(Supplementary note 3) The semiconductor device according to supplementary note 1, wherein the third transistor has gate and drain terminals connected.
(Supplementary note 4) The semiconductor device according to supplementary note 1, wherein the third transistor has a gate terminal to receive a voltage from a voltage generation circuit.
(Supplementary note 5) The semiconductor device according to supplementary note 1, comprising

a plurality of the inverters connected in cascade.

Various combinations and selections of various disclosed elements (including each element of each claim, each element of each example, each element of each drawing, and the like) are possible within the scope of the claims of the present invention. That is, the present invention of course includes various variations and modifications that could be made by those skilled in the art according to the overall disclosure including the claims and the technical concept.

What is claimed is:

1. A semiconductor device comprising:
an inverter including first and second transistors arranged between first and second power supplies having mutually different power supply voltage, the first and second transistors having gate terminals coupled together; and
a first circuit connected between the first and second transistors,
the first circuit including
a first resistance element and a third transistor connected to each other in parallel.

2. The semiconductor device according to claim 1, wherein the first resistance element has a positive temperature characteristic, and the third transistor operates at least in a region in which the resistance between the drain and source terminals of the third transistor exhibits a negative temperature characteristic.

3. The semiconductor device according to claim 1, wherein the first circuit further includes:
a second resistance element connected between one end of the first resistance element and one of the first transistor and the second transistor.

4. The semiconductor device according to claim 1, comprising:
a voltage generation circuit that supplies a voltage to a gate terminal of the third transistor.

5. The semiconductor device according to claim 1, wherein the third transistor has a diode connection configuration.

6. The semiconductor device according to claim 1, wherein the second and third transistors have the same conductivity type, and
the first transistor has a conductivity type opposite to the conductivity type of the second and third transistors.

7. The semiconductor device according to claim 1, comprising
first and second ones of the inverters, wherein
the first inverter includes:
a first input node connected to the coupled gate terminals of the first and second transistors included in the first inverter; and
a first output node connected between one end of the first circuit included in the first inverter and one of the first and second transistors included in the first inverter, and wherein
the second inverter includes:
a second input node connected to the coupled gate terminals of the first and second transistors included in the second inverter; and
a second output node connected between one end of the first circuit included in the second inverter and one of the first and second transistors included in the second inverter,
the first output node included in the first inverter being connected to the second input node included in the second inverter.

8. The semiconductor device according to claim 7, wherein in the first circuit of the first inverter,
the first transistor has a first conductivity type, and
the second and third transistors have a second conductivity type opposite to the first conductivity type,
the first and second transistors having source terminals connected to the first and second power supplies, respectively, and wherein
in the first circuit of the second inverter,
the first transistor has the second conductivity type, and
the second and third transistors have the first conductivity type,
the first and second transistors having source terminals connected to the second and first power supplies, respectively.

9. A semiconductor device comprising:
a first power supply line to supply a first power supply voltage;
a second power supply line to supply a second power supply voltage different from the first power supply voltage; and
an inverter that includes:
a first node;
a second node;
an input node to receive a signal;
an output node to output an inverted version of the received signal;
a first transistor connected between the first power supply line and the first node;
a second transistor connected between the second power supply line and the second node, the first and second transistors having gate terminals coupled together to the input node; and
a first circuit connected between the first and second nodes,
the first circuit including a first resistance element and a third transistor connected in parallel with the first resistance element,
the first resistance element having a positive temperature characteristic,
the third transistor operating at least in a region of operation in which a resistance value between drain and source terminals of the third transistor exhibits a negative temperature characteristic, when charging or discharging a capacitor connected to the output node.

10. The semiconductor device according to claim 9, comprising
a voltage generation circuit that supplies a gate voltage to the third transistor.

11. The semiconductor device according to claim 9, wherein the third transistor has a gate terminal and a drain terminal coupled together.

12. The semiconductor device according to claim 9, wherein the first circuit further includes
a second resistance element between one of the first and second transistors and a connection node of the first resistance element and the drain terminal of the third transistor.

13. The semiconductor device according to claim 9, wherein the third transistor is biased to operate at least in a region of operation in which a drain current of the third transistor has a positive temperature characteristic.

14. A semiconductor device comprising:
first and second voltage terminals respectively supplied with first and second potentials different from each other; and
a first inverter circuit including:
input and output nodes;
first and second transistors provided in series between the first and second voltage terminals, the first and second transistors having gates coupled in common to the input node; and
a first resistance circuit provided between the first and second transistors,
the first resistance circuit including:
a first node coupled to the first transistor and the output node;
a second node coupled to the second transistor, and
a first resistance element and a third transistor provided in parallel between the first and second nodes.

15. The semiconductor device according to claim 14, wherein the first resistance circuit further includes
a second resistance element between the first node and the first resistance element.

16. The semiconductor device according to claim 14, further comprising
a second inverter circuit that includes:
an additional input node coupled to the output node of the first inverter circuit;
an additional output node;
fourth and fifth transistors provided in series between the first and second voltage terminals, the fourth and fifth transistors having gates coupled in common to the additional input node; and
a second resistance circuit provided between the fourth and fifth transistors, the second resistance circuit including:
a third node coupled to the fourth transistor,
a fourth node coupled to the fifth transistor and the additional output node; and
a third resistance element and a sixth transistor provided in parallel between the third and fourth nodes.

17. The semiconductor device according to claim 14, wherein the first and second transistors are different in conductivity type from each other.

18. The semiconductor device according to claim 16, wherein the first and fourth transistors are same in conductivity type as each other, the second and fifth transistors being same in conductivity type as each other, and the third and sixth transistors being different in conductivity type from each other.

19. The semiconductor device according to claim 18, wherein the first and fourth transistors comprise P-type transistors, the second and fifth transistors comprising N-type transistors, the third transistor comprising the N-type transistor, and the sixth transistor comprising the P-type transistor.

20. The semiconductor device as claimed in claim 14, wherein the third transistor has a temperature characteristic reverse to that of the first resistance element.
